(19) United States
(12) Patent Application Publication
(10) Pub. No.: US 2018/0275265 A1
(43) Pub. Date: Sep. 27, 2018

(54) TARGET TRACKING USING REGION COVARIANCE

(71) Applicant: GM GLOBAL TECHNOLOGY OPERATIONS LLC, Detroit, MI (US)

(72) Inventors: Igal Bilik, Rehovot (IL); Ishai Eljarat, Jerusalem (IL); Shahar Villeval, Tel Aviv (IL)

(21) Appl. No.: 15/467,465

(22) Filed: Mar. 23, 2017

(51) Int. Cl. G01S 13/72; G01S 13/93

(52) U.S. Cl. CPC G01S 13/723; G01S 13/931

(57) ABSTRACT

A vehicle, system and method for tracking an object with respect to the vehicle. A radar system receives a first plurality of detections from an object during a first time frame and a second plurality of detection during a second time frame. A region covariance matrix is calculated for a cluster formed from the first plurality of detections. An updated covariance matrix for the cluster is calculated from the region covariance matrix of the first time frame. A region covariance matrix is calculated for each of a plurality of clusters formed from the second plurality of detections. A metric is determined between the updated covariance matrix and each region covariance matrix from the second time frame. The object is tracked by associating the region covariance matrix from the second time frame having the smallest metric to the region covariance matrix of the first time frame.

### INTRODUCTION

The subject disclosure relates to tracking motion of an object using a radar system and, in particular, to a method for tracking a progression of a cluster of radar detections received from the object over a plurality of time frames.

Vehicular tracking systems employ radar systems that generate one or more source signals during each of a plurality of time frames and, in response, receive a plurality of radar detections during each of the plurality of time frames. For a selected time frame, each object in the vehicle's environment that receives the one or more source signals of the time frame produces a plurality of radar echoes or reflections, also referred to herein as detections. In order to process the plurality of detections efficiently, it is useful to group the detections of a selected time frame into separate clusters, with each cluster representing an object in the vehicle's environment during the time frame. As the object moves with respect to the radar system, the detections associated with the object moves within the frame of reference of the radar system. Therefore, in order to track the object efficiently, the cluster representative of the object during one time frame needs to be correctly associated with a cluster representative of the object during a subsequent time frame. This association can be complicated when multiple objects are being detected and when objects are close to each other. Accordingly, it is desirable to provide a method of associating a cluster from one time frame with a cluster from a subsequent time frame in order to track an object that is associated with these clusters.

### SUMMARY

In one exemplary embodiment, a method of tracking an object is disclosed. The method includes calculating a region covariance matrix for a cluster of detections representative of the object in a first time frame, calculating an updated covariance matrix for the cluster from the region covariance matrix of the first time frame, calculating a region covariance matrix for each of a plurality of clusters of detections in a second time frame, determining a plurality of metrics, wherein each metric is determined between the updated covariance matrix and a region covariance matrix from the second time frame, and tracking the object by associating the region covariance matrix from the second time frame having the smallest metric to the region covariance matrix of the first time frame.

By associating the region covariance matrix from the second time frame having the smallest metric to the region covariance matrix of the first time frame, a cluster in the first time frame is associated with a cluster in the second time frame corresponding to the associated region covariance matrix of the second time frame. Calculating the updated covariance matrix for the cluster further includes applying Lie algebra to the vector space of the region covariance matrix of the first time frame. Calculating the updated covariance matrix includes time-evolving the region covariance matrix of the first time frame to the second time frame. In one embodiment, the cluster of detections representative of the object is obtained by receiving, during the first time frame, a reflection of a source signal transmitted toward the object during the first time frame. When a path is determined with respect to the tracked object, a vehicle may be maneuvered along the path to avoid the tracked object.

In another exemplary embodiment, a system for driving a vehicle is disclosed. The system includes a radar system that receives a first plurality of detections from an object during a first time frame and a second plurality of detection during a second time frame, and a processor. The processor is configured to calculate a region covariance matrix for a cluster representative of the object in the first time frame, wherein the cluster is formed from the first plurality of detections, calculate an updated covariance matrix for the cluster from the region covariance matrix of the first time frame; calculate a region covariance matrix for each of a plurality of clusters in a second time frame, wherein the plurality of clusters is formed from the second plurality of detections, determine a plurality of metrics, wherein each metric is determined between the updated covariance matrix and a region covariance matrix from the second time frame, and track the object by associating the region covariance matrix from the second time frame having the smallest metric to the region covariance matrix of the first time frame.

The processor may associate the cluster in the first time frame with a cluster in the second time frame corresponding to the associated region covariance matrix of the second time frame by associating the region covariance matrix from the second time frame having the smallest metric to the region covariance matrix of the first time frame. The processor may calculate the updated covariance matrix for the cluster by applying Lie algebra to the vector space of the region covariance matrix of the first time frame. In one embodiment, calculating the updated covariance matrix for the cluster includes time-evolving the region covariance matrix of the first time frame to the second time frame. The processor may obtain the first plurality of detections by receiving, during the first time frame, a reflection of a source signal transmitted toward the object during the first time frame. The second plurality of detections may include detections received from the object and from at least one other object. In one embodiment, the system includes an autonomous driving system that maneuvers a vehicle along a path determined with respect to the tracked object.

In yet another exemplary embodiment, a vehicle is disclosed. The vehicle includes a radar system that receives a first plurality of detections from an object during a first time frame and a second plurality of detection from the object during a second time frame, and a processor. The processor is configured to calculate a region covariance matrix for a cluster representative of the object in the first time frame, wherein the cluster is formed from the first plurality of detections, calculate an updated covariance matrix for the cluster from the region covariance matrix of the first time frame, calculate a region covariance matrix for each of a plurality of clusters in a second time frame, wherein the plurality of clusters is formed from the second plurality of detections, determine a plurality of metrics, wherein each metric is determined between the updated covariance matrix and a region covariance matrix from the second time frame, and track the object by associating the region covariance matrix from the second time frame having the smallest metric to the region covariance matrix of the first time frame.

The processor may associate the cluster in the first time frame with a cluster in the second time frame corresponding to the associated region covariance matrix of the second time frame by associating the region covariance matrix from the second time frame having the smallest metric to the region covariance matrix of the first time frame. The processor may calculate the updated covariance matrix for the cluster by applying Lie algebra to the vector space of the region covariance matrix of the first time frame. In one embodiment, calculating the updated covariance matrix for the cluster includes time-evolving the region covariance matrix of the first time frame to the second time frame. The processor may obtain the first cluster of detections by receiving, during the first time frame, a reflection of a source signal transmitted toward the object during the first time frame. The second plurality of detections may include detections received from the object and from at least one other object. In one embodiment, the vehicle includes an autonomous driving system that maneuvers the vehicle along a path determined with respect to the tracked object.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle that includes an autonomous driving system that navigates the vehicle with respect to various objects or targets in the environment of the vehicle;

FIG. 2 illustrates a tracking map showing a plurality of detections received from one or more objects during a single time frame;

FIG. 3 illustrates a map that includes multiple clusters formed from the plurality of clusters during a single time frame;

FIG. 4 is a diagram that illustrates schematically the tracking operation of the present disclosure; and

FIG. 5 shows a flowchart for tracking an object using the methods disclosed herein.

### DETAILED DESCRIPTION

The following description is merely exemplary in nature and is not intended to limit the present disclosure, its application or uses. It should be understood that throughout the drawings, corresponding reference numerals indicate like or corresponding parts and features.

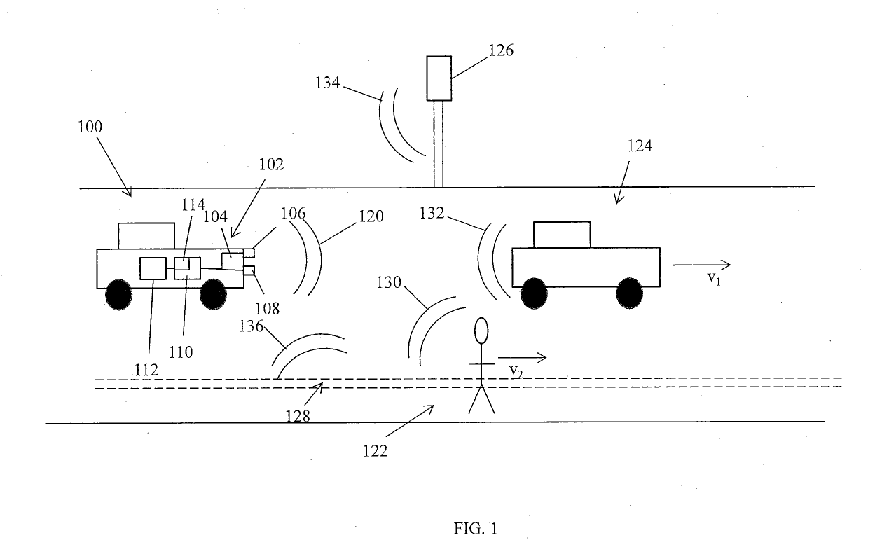

In accordance with an exemplary embodiment of the disclosure, FIG. 1 shows a vehicle 100, such as an automobile, that includes an autonomous driving system 102 that navigates the vehicle 100 with respect to various objects or targets in the environment of the vehicle 100. The autonomous driving system 102 includes a radar system 104 suitable for providing radio frequency signals that can be used to determine a distance and/or a relative velocity of various objects with respect to the vehicle 100. In the embodiment shown in FIG. 1, the radar system 104 includes a transmitter 106 and a receiver 108. In alternate embodiments, the radar system 104 may be a MIMO (multi-input, multi-output) radar system that includes an array of transmitters and an array of receivers. The radar system 104 controls and operates the transmitter 106 to generate a radio frequency wave front (a “source signal” 120). In one embodiment, the source signal 120 includes a linear frequency-modulated continuous wave (LFM-CW), often referred to as a chirp signal. Alternately, the source signal 120 can be a pulsed signal or a combination of pulsed and chirp signals.

The source signal 120 is reflected off of various objects in the environment of the vehicle 100. Exemplary objects shown in FIG. 1 include, but are not limited to, a pedestrian 122, an external vehicle 124, a light post 126 and a curb 128. Some of these objects (e.g., light post 126 and curb 128) are motionless in their environment, while other objects (e.g., pedestrian 122 and external vehicle 124) are in motion with respect to their environment. Motion of the external vehicle 124 is indicated by vector v₁ and motion of the pedestrian 122 is indicted by vector v₂. Each of these objects generates one or more reflected signals in response to receiving the source signal 122. Pedestrian 122 generates reflected signal 130, and external vehicle 124 generates reflected signal 132. Light post 126 generates reflected signal 134, and curb 128 generates reflected signal 136. The reflected signals are received at the receiver 108 of the radar system 104, which generally includes circuitry for sampling the reflected signals. Reflected signals are provided from the radar system 104 to a control unit 110 which includes a processor 114 that performs the methods disclosed herein for tracking objects.

In one embodiment, the radar system 104 transmits sources signals 120 and receives reflected signals for each of a plurality of time frames. For a selected time frame, the transmitter 106 transmits one or more source signals and the receiver 108 receives a plurality of reflected signals or “detections” resulting from reflections of the one or more source signals off of the various objects in the environment of the vehicle 100. Each object that receives the one or more source signals can transmit a plurality of reflected signals. Therefore, the plurality of detections received at the receiver 108 may include one set of detections associated with (or received from) a first object, another set of detections associated with (or received from) a second object, etc. The control unit 110 includes a processor 114 that performs methods to group a set of detections into clusters in order to provide a cluster representative of an object in the vehicle's environment. For each time frame, the processor 114 groups the plurality of detections into one or more clusters using grouping methods so that a cluster of detections is associated with an object in the environment. As the object moves within the frame of reference of the radar system 104, the cluster of detections associated with the object moves accordingly within the reference frame of the radar system 104 from one time frame to the next. The processor 114 performs the methods disclosed herein to associate a cluster representative of an object in one time frame with a cluster representative of the object in another time frame. Such association of clusters over time frames allows the processor to track the object. A tracked object can be provided to the collision-avoidance system 112 in order to enhance driving safety.

The collision-avoidance system 112 may control steering and acceleration/deceleration components to perform vehicle maneuvers to avoid the object. By tracking the object, the vehicle 100 can, for example, maneuver by accelerating, decelerating or steering the vehicle in order to avoid the object. Alternatively, the control unit 110 can provide a signal to alert a driver of the vehicle 100 so that the driver can take any suitable action to avoid the object.

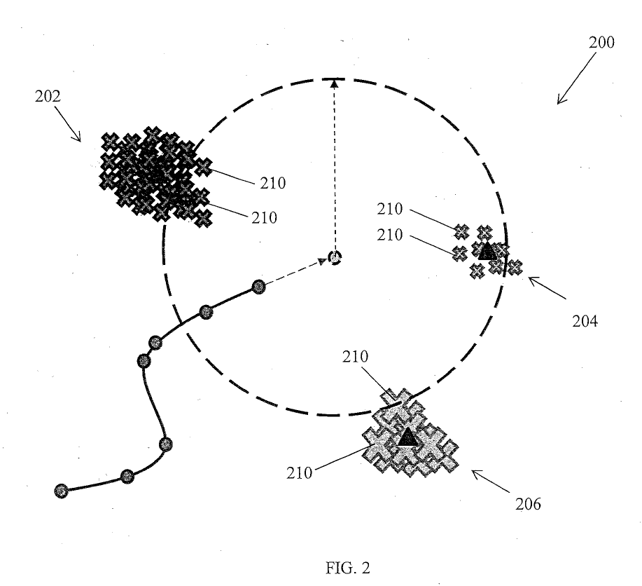

FIG. 2 illustrates a tracking map 200 showing a plurality of detections 210 received from one or more objects during a single time frame. The detections 210 are shown to form clusters, e.g., cluster 1 (202), cluster 2 (204) and cluster 3 (206). Each cluster can be associated with an object in the environment. Often a cluster of detections can take a form that is indicative of its associated object. For example, a cluster associated with a vehicle can take on an L-shape, a cluster associated with a curb can take on a horizontal linear configuration and a cluster associated with a pole can take on a vertical configuration.

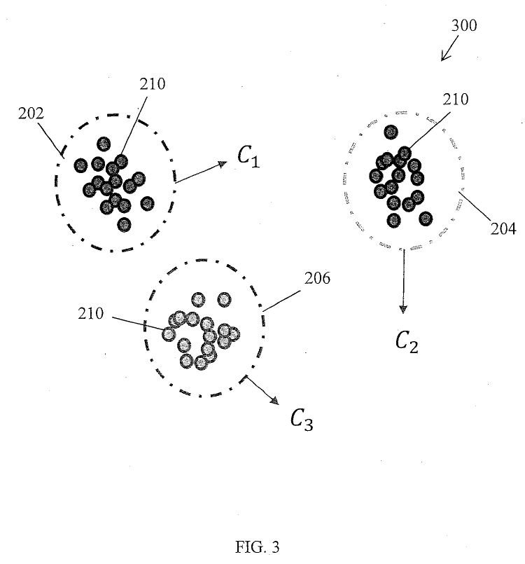

FIG. 3 illustrates a map 300 that includes multiple clusters formed from the plurality of detections 210 during a single time frame. The processor 114 associates the plurality of detections 210 received during the time frame into the various illustrative clusters 202, 204 and 206. Each detection 210 is represented by its feature vector. A feature vector f(x, y, z, vel) for a detection includes a position vector and a velocity vector of the detection with respect to an origin or reference frame for the radar system 104. Detections are often associated with a cluster for which the distance between the detection and the mean feature vector is a minimum. Once the detections are associated with a cluster, a mean feature vector μ for each cluster can be determined. The mean feature vector μ for a cluster includes a mean position vector that is an average of the positon vectors of the detections in the cluster and a mean velocity vector that is an average of the velocity vectors of the detections in the cluster.

Once a cluster has been identified and its mean feature vector μ has been calculated, a region covariance matrix can be calculated for the cluster. An exemplary region covariance matrix is expressed in Eq. (1):

$$C = \frac{1}{{N}_{detect}} {\sum }_{k = 1}^{{N}_{detect}} ( {f}_{k} - μ ) {( {f}_{k} - μ )}^{T} \qquad Eq . ( 1 )$$

where N_{detect} is a number of detections in the cluster, fₖ is a feature vector for the k-th detection in the cluster and μ is the mean feature vector of the cluster. The region covariance matrices for the first cluster 202, second cluster 204 and third cluster 206 of FIG. 2 are therefore given respectively by Equations (2)-(4):

$$\begin{matrix}{C}_{1} = \frac{1}{{N}_{detect 1}} {\sum }_{k = 1}^{{N}_{detect 1}} ( {f}_{k}^{( 1 )} - {μ}_{1} ) {( {f}_{k}^{( 1 )} - {μ}_{1} )}^{T} & Eq . ( 2 ) \\ {C}_{2} = \frac{1}{{N}_{detect 2}} {\sum }_{k = 1}^{{N}_{detect 2}} ( {f}_{k}^{( 2 )} - {μ}_{2} ) {( {f}_{k}^{( 2 )} - {μ}_{2} )}^{T} & Eq . ( 3 ) \\ {C}_{3} = \frac{1}{{N}_{detect 3}} {\sum }_{k = 1}^{{N}_{detect 3}} ( {f}_{k}^{( 3 )} - {μ}_{3} ) {( {f}_{k}^{( 3 )} - {μ}_{3} )}^{T} & Eq . ( 4 )\end{matrix}$$

These region covariance matrices, which are representative of objects during a particular time frame, can be compared with region covariance matrices of clusters in other time frames in order to track motion of the objects.

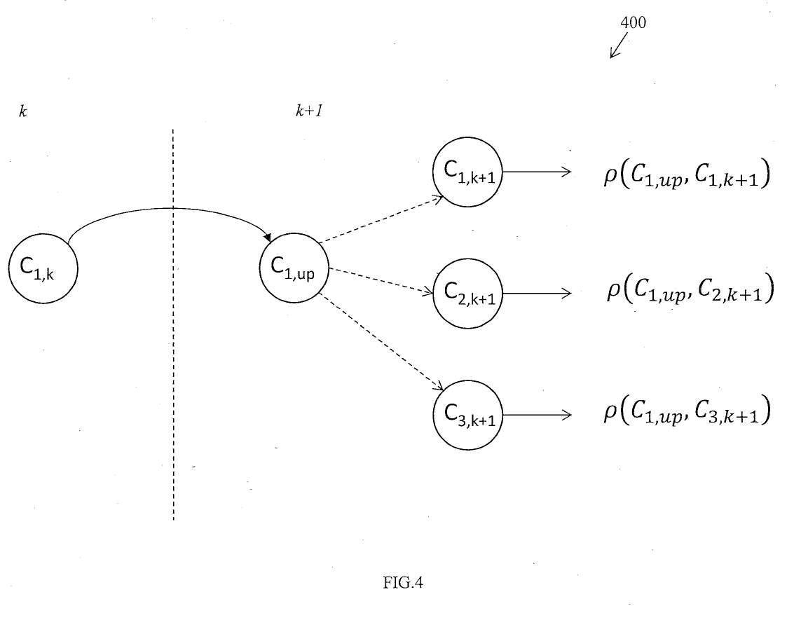

In order to track a particular object across time frames, the region covariance matrix for a cluster representing the particular object in a first time frame is “updated” to obtain an updated region covariance matrix that represents the object during a second or subsequent time frame. Various methods can be used to update the region covariance matrix from one time frame to another time frame. In one embodiment, applying a Lie algebra over the vector space of the region covariance matrix of the first time frame provides the updated region covariance matrix for the second time frame. Once the updated region covariance matrix is obtained, it can be compared to region covariance matrices for the second time frame it order to determine a closest match. This method is discussed with respect to FIG. 4.

FIG. 4 is a diagram 400 that illustrates schematically the tracking operation of the present disclosure. A region covariance matrix C_{1,k} is calculated for a first cluster during a first time frame (time frame k). The region covariance matrix is then updated C_{1,k}→C_{1,up}, where C_{1,up} is a result of change that occurs to the first cluster between the first time frame and a second frame. For the second time frame (time frame k|1), clusters are formed from the plurality of detections obtained during the second time frame, and corresponding region covariance matrices are determined for these clusters. The region covariance matrices for the clusters of the second time frame are represented by C_{1,k-1}, C_{2,k+1}, C_{3,k+1}. For each cluster of the second time frame, a distance or metric is determined between the corresponding region covariance matrix and the updated covariance matrix C_{1,up}. In one embodiment, the metric between two covariance matrices is calculated using Eq. (4):

ρ(Cᵢ, Cⱼ)=\sqrt{Σₖ₌₁^{d}ln²[λₖ(Cᵢ, Cⱼ)]} Eq. (4)

where (Cᵢ, Cⱼ) is the product of Cᵢ and Cⱼ and λₖ (Cᵢ, Cⱼ) are the generalized eigenvalues of this product. Thus, metrics ρ(C_{1,up}, C_{1,k+1}), ρ(C_{1,up}, C_{2,k+1}) and ρ(C_{1,up}, C_{3,k+1}) are calculated for their respective region covariance matrices of the second time frame (i.e., C_{1,k+1}, C_{2,k+1}. C_{3,k+1}). The region covariance matrix of the second time frame that provides the smallest metric (min|ρ(Cᵢ, Cⱼ)|) is determined to be associated with the cluster of the second time frame that best matches with the cluster from the first time frame. Thus, the cluster of the first time frame can be associated with a cluster of the second time frame, thereby allowing tracking of the object.

FIG. 4 shows the comparison of a single cluster in a first time frame with three clusters in a second time frame. However, this is meant only for illustrative purposes. A plurality of clusters in the first time frame can be compared to a plurality of clusters in the second time frame in order to provide associations between clusters across time frames that allow tracking for a plurality of objects.

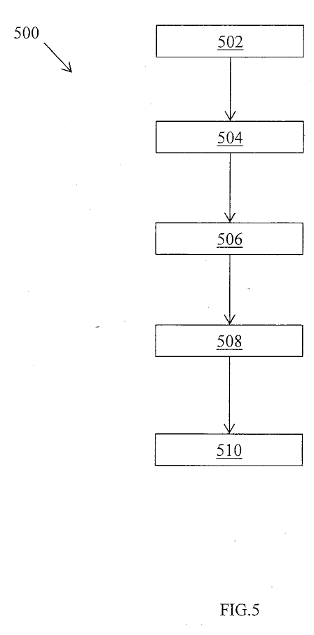

FIG. 5 shows a flowchart 500 for tracking an object using the methods disclosed herein. In Box 502, a region covariance matrix is formed for a cluster in a first time frame, where the cluster in the first time frame is determined from detections received from the object during the first time frame. In Box 504, an updating method is performed on the region covariance matrix to obtain an updated covariance matrix representing the cluster in a second time frame. In Box 506, a region covariance matrix is formed for each of a plurality of cluster in the second time frame, wherein each cluster in the second time frame is determined from detections received during the second time frame. In Box 508, a metric is calculated between the updated covariance matrix and one or more of the region covariance matrices of the second time frame. In Box 510, the cluster associated with the region covariance matrix having the smallest metric with respect to the updated region covariance matrix is associated with the cluster in the first time frame. The associated clusters therefore represent the same object in two different time frames, i.e., the first time frame and the second time frame. The motion of an object can be tracked by continuing this process over a plurality of time frames.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the disclosure not be limited to the particular embodiments disclosed, but will include all embodiments falling within the scope of the application.

What is claimed is:

1. A method of tracking an object, comprising:
calculating a region covariance matrix for a cluster of detections representative of the object in a first time frame;
calculating an updated covariance matrix for the cluster from the region covariance matrix of the first time frame;
calculating a region covariance matrix for each of a plurality of clusters of detections in a second time frame;
determining a plurality of metrics, wherein each metric is determined between the updated covariance matrix and a region covariance matrix from the second time frame; and
tracking the object by associating the region covariance matrix from the second time frame having the smallest metric to the region covariance matrix of the first time frame.

2. The method of claim 1, wherein associating the region covariance matrix from the second time frame having the smallest metric to the region covariance matrix of the first time frame associates a cluster in the first time frame with a cluster in the second time frame corresponding to the associated region covariance matrix of the second time frame.

3. The method of claim 1, wherein calculating the updated covariance matrix for the cluster further comprises applying Lie algebra to the vector space of the region covariance matrix of the first time frame.

4. The method of claim 1, wherein calculating the updated covariance matrix further comprises time-evolving the region covariance matrix of the first time frame to the second time frame.

5. The method of claim 1, further comprising obtaining the cluster of detections representative of the object by receiving, during the first time frame, a reflection of a source signal transmitted toward the object during the first time frame.

6. The method of claim 1, wherein comprising maneuvering a vehicle along a path determined with respect to the tracked object.

7. A system for driving a vehicle, comprising:
a radar system that receives a first plurality of detections from an object during a first time frame and a second plurality of detection during a second time frame; and
a processor configured to:
calculate a region covariance matrix for a cluster representative of the object in the first time frame, wherein the cluster is formed from the first plurality of detections;
calculate an updated covariance matrix for the cluster from the region covariance matrix of the first time frame;
calculate a region covariance matrix for each of a plurality of clusters in a second time frame, wherein the plurality of clusters is formed from the second plurality of detections;
determine a plurality of metrics, wherein each metric is determined between the updated covariance matrix and a region covariance matrix from the second time frame; and
track the object by associating the region covariance matrix from the second time frame having the smallest metric to the region covariance matrix of the first time frame.

8. The system of claim 7, wherein the processor associates the cluster in the first time frame with a cluster in the second time frame corresponding to the associated region covariance matrix of the second time frame by associating the region covariance matrix from the second time frame having the smallest metric to the region covariance matrix of the first time frame.

9. The system of claim 7, wherein the processor calculates the updated covariance matrix for the cluster by applying Lie algebra to the vector space of the region covariance matrix of the first time frame.

10. The system of claim 7, wherein calculating the updated covariance matrix for the cluster further comprising time-evolving the region covariance matrix of the first time frame to the second time frame.

11. The system of claim 7, wherein the processor obtains the first plurality of detections by receiving, during the first time frame, a reflection of a source signal transmitted toward the object during the first time frame.

12. The system of claim 7, wherein the second plurality of detections includes detections received from the object and from at least one other object.

13. The system of claim 7, further comprising an autonomous driving system that maneuvers a vehicle along a path determined with respect to the tracked object.

14. A vehicle, comprising:
a radar system that receives a first plurality of detections from an object during a first time frame and a second plurality of detection from the object during a second time frame; and
a processor configured to:
calculate a region covariance matrix for a cluster representative of the object in the first time frame, wherein the cluster is formed from the first plurality of detections;
calculate an updated covariance matrix for the cluster from the region covariance matrix of the first time frame;
calculate a region covariance matrix for each of a plurality of clusters in a second time frame, wherein the plurality of clusters is formed from the second plurality of detections;
determine a plurality of metrics, wherein each metric is determined between the updated covariance matrix and a region covariance matrix from the second time frame; and
track the object by associating the region covariance matrix from the second time frame having the smallest metric to the region covariance matrix of the first time frame.

15. The vehicle of claim 13, wherein the processor associates the cluster in the first time frame with a cluster in the second time frame corresponding to the associated region covariance matrix of the second time frame by associating the region covariance matrix from the second time frame having the smallest metric to the region covariance matrix of the first time frame.

16. The vehicle of claim 13, wherein the processor calculates the updated covariance matrix for the cluster by applying Lie algebra to the vector space of the region covariance matrix of the first time frame.

17. The vehicle of claim 13, wherein calculating the updated covariance matrix for the cluster further comprising time-evolving the region covariance matrix of the first time frame to the second time frame.

18. The vehicle of claim 13, wherein the processor obtains the first cluster of detections by receiving, during the first time frame, a reflection of a source signal transmitted toward the object during the first time frame.

19. The vehicle of claim 13, wherein the second plurality of detections includes detections received from the object and from at least one other object.

20. The vehicle of claim 13, further comprising an autonomous driving system that maneuvers the vehicle along a path determined with respect to the tracked object.
